(19) United States
(12) Patent Application Publication
(10) Pub. No.: US 2026/0077897 A1
(43) Pub. Date: Mar. 19, 2026

(54) PRODUCT HANDLING DEVICE AND METHOD FOR COMPRESSING INDIVIDUAL PRODUCT GROUPS OF TRANSPORTED PRODUCTS

(71) Applicant: Syntegon Packaging Systems AG, Beringen (CH)

(72) Inventor: Raffael Waespi, Hemishofen (CH)

(21) Appl. No.: 19/321,504

(22) Filed: Sep. 8, 2025

(30) Foreign Application Priority Data
Sep. 17, 2024 (DE) 10 2024 126 777.1

(51) Int. Cl. B65B 35/40; B65B 63/02; B65G 47/28; B65G 47/82

(52) U.S. Cl. CPC B65B 35/40; B65B 63/02; B65G 47/28; B65G 47/82; B65G 2201/0205; B65G 2203/0283

(57) ABSTRACT

A product handling device for a packaging machine includes at least one transport unit (14) for a transport of products (16) along a transport direction (18) of the transport unit (14), and at least one compression unit (20) for a compression of individual product groups of the products (16) transported by the transport unit (14). The compression unit (20) has at least one compression element (22), which is supported so as to be movable, wherein the compression element (22) is movable along the transport direction (18) together with at least one transport element (24) of the transport unit (14) on which the products (16) can be arranged.

### CROSS-REFERENCE TO RELATED APPLICATIONS

This patent application is based on and claims priority to German patent application DE 102024126 777.1, which was filed on September 17, 2024 and the contents of which are incorporated herein by reference.

### BACKGROUND

The invention concerns a product handling device for a packaging machine.

In already known product handling devices, a compression is brought about by means of a pivotably supported compression element which is configured to exert an impulse force, in particular an impact, onto an end face of the product groups of the products transported by the transport unit. The compression element of the known product handling devices needs to be pivoted back into an initial position after a pivoting movement by which the product groups can be compressed; this may result in low production output of the known product handling devices due to a respectively required resetting time of the compression element. Moreover, in particular if the products are realized as food products, such as for example biscuits or the like, the products may get damaged by the exertion of the impulse force, in particular the impact, onto the products. Furthermore, by the exertion of the impulse force, in particular the impact, onto the products, individual products may be moved out of the product group that is to be compressed, in particular if the impulse force is too strong, which may result in production disruption.

### SUMMARY

The objective of the invention is in particular to provide a generic product handling device, a generic method and a generic packaging machine having improved properties with regard to gentle product handling, to production output, to production reliability and/or to accuracy of a length measurement of product groups. The objective is achieved according to the invention.

The invention is based on a product handling device for a packaging machine, with at least one transport unit for a transport of products along a transport direction of the transport unit, and with at least one compression unit for a compression of individual product groups, in particular of product rows oriented transversely to the transport direction, of the products transported by the transport unit, wherein the compression unit comprises at least one compression element, in particular at least one plunger, which is supported so as to be, in particular translationally, movable.

It is proposed that the compression element is, in particular at least temporarily, movable along the transport direction together with, preferably synchronously with, at least one transport element of the transport unit on which the products can be arranged. The implementation of the product handling device according to the invention advantageously allows realizing a compression element that can be moved along with the products and/or the product groups along the transport direction, so that advantageously gentle product handling, high production output, high production reliability and/or high accuracy of a length measurement of product groups are/is achievable. Due to the implementation of the product handling device according to the invention, it is advantageously possible to realize product-gentle compression of individual product groups over a movement path of the product groups along the transport direction, such that advantageously there is no abrupt compression but rather a slow and uniform compression of the product groups while they are still being moved along the transport direction. This may in particular have a positive effect on product handling and on the accuracy of a length measurement of product groups. Advantageously, it is possible to realize – depending on a movement of the products along the transport direction – a continuous compression movement of the compression element along a direction that runs transversely to the transport direction. Due to the implementation of the product handling device according to the invention, it is advantageously possible to realize, in a structurally simple manner, a compression with a continuously increasing compression force. Advantageously, low-noise compression of the product groups can be realized, since compression does not take place abruptly at one point in time like in the prior art, but may advantageously take place continuously over a certain period of time.

The product handling device is preferably part of a packaging machine for a packaging of products, in particular food products, preferably confectionery products, such as for example chocolate coins, wafers, biscuits or the like. Preferably, the product handling device is configured for a handling, such as for example for a transport, for an orientation, for a sorting, for a compression or the like, of products. The transport unit is preferably realized as a rod conveyor unit, in particular as a transverse rod conveyor unit. However, it is also conceivable that the transport unit has a different implementation deemed expedient by someone skilled in the art, such as for example an implementation as a chain conveyor, as a conveyor belt, as a belt conveyor, as an electrodynamic linear or planar transport system, the functionality and construction of which is already known to someone skilled in the art under the product names XTS® or XPlanar® of the company Beckhoff Automation GmbH & Co. KG, or the like. The transport direction preferably runs at least substantially parallel to a horizontal plane. Preferably the transport direction runs at least substantially parallel to a longitudinal axis of the transport unit. “Substantially parallel” is in particular to mean an orientation of a direction relative to a reference direction, in particular in a plane, wherein the direction has a deviation from the reference direction that is in particular smaller than 8°, advantageously smaller than 5° and especially advantageously smaller than 2°. Preferably the transport unit comprises at least one transport element, which is preferably realized as a rod belt, preferably as a transverse rod belt. Preferentially the transport element is realized as a circulating rod belt. The transport element is preferably supported so as to be movable, in particular in a circulating manner, on a guide unit, in particular a frame, of the transport unit. The transport unit preferably comprises at least one drive unit for a movement, in particular for a circulating drive, of the transport element relative to the frame of the transport unit. The drive unit of the transport unit preferably comprises at least one electric motor. In particular, the electric motor of the drive unit of the transport unit is configured for a rotating drive of a drive element, in particular a drive pinion, a drive roller or the like, of the drive unit of the transport unit, said drive element being configured, in a manner already known to someone skilled in the art, for a transmission of a drive force to the transport element. “Configured” is in particular to mean specially programmed, specially furnished, specially designed and/or specially equipped. By an object or a unit being configured for a specific function is in particular to be understood that the object or the unit fulfils and/or carries out this specific function in at least one application state and/or operation state. The electric motor of the drive unit of the transport unit may be connected directly to the drive element or may be connected to the drive element indirectly, for example via a gear, a belt drive, a chain, a gear wheel or the like. The drive unit of the transport unit may alternatively or additionally comprise further components which are deemed expedient by someone skilled in the art and which are configured for a drive of the transport element, or the drive unit of the transport unit may have a different implementation deemed expedient by someone skilled in the art. The transport unit is preferably configured to transport the products along the transport direction in such a manner that the products are oriented transversely, in particular at least substantially perpendicularly, to the transport direction in rows, in particular as a result of an arrangement of individual product groups of the products in each case between two transverse rods of the transport unit. The term “substantially perpendicularly” is in particular meant to define an orientation of a direction relative to a reference direction, wherein the direction and the reference direction, in particular viewed in a projection plane, include a 90° angle and the angle has a maximum deviation of in particular less than 8°, advantageously less than 5° and especially advantageously less than 2°.

The compression unit is preferably configured for a compression of the individual product groups which are arranged between two transverse rods, in particular of product rows oriented transversely to the transport direction, of the products transported by the transport unit. Preferably, individual products of the individual product groups are movable towards one another by the compression unit along a direction that runs transversely to the transport direction, in particular at least substantially perpendicularly to the transport direction and at least substantially parallel to the horizontal plane, preferably until the products of the individual product groups bear against one another. The compression unit preferably comprises at least the, in particular translationally, movably supported compression element for an effect, in particular a force effect, along the direction that runs transversely to the transport direction, on the products of the individual product groups. For an effect on the products of the individual product groups at least along the direction that runs transversely to the transport direction, in particular at least substantially perpendicularly to the transport direction and at least substantially parallel to the horizontal plane, the compression element is preferably supported so as to be translationally movable relative to the transport unit. However, it is also conceivable that the compression element, in particular at least for an effect on the products of the individual product groups, is alternatively or additionally supported so as to be movable relative to the transport unit in a different manner and along a different direction, deemed expedient by someone skilled in the art. The compression element is preferably realized as a plunger. However, it is also conceivable that the compression element has a different implementation deemed expedient by someone skilled in the art, such as for example an implementation as a slider, as a rod, as a rake or the like. Preferably, the compression unit comprises a plurality of compression elements, the individual compression elements being in each case configured for an effect, in particular a force effect along the direction that runs transversely to the transport direction, on the products of the individual product groups. The compression elements are preferably implemented identically. However, it is also conceivable that the compression elements are implemented in different ways.

The compression element is, in particular at least temporarily, movable along the transport direction together with, preferably synchronously with, the transport element of the transport unit on which the products can be arranged. The compression unit preferably comprises at least one drive unit for a movement of the compression element/s along the transport direction relative to the frame of the transport unit. The drive unit of the compression unit is preferably configured to move the compression element/s in a circulating manner on or with a guiding and/or driving track that is arranged laterally offset relative to the transport element and/or relative to the frame of the transport unit, in particular in order to move the compression element/s along the transport direction at least temporarily together with, preferably synchronously with, the transport element of the transport unit on which the products can be arranged. A maximum extent of the guiding and/or driving track along a direction that runs at least substantially parallel to the transport direction is preferably smaller than a maximum extent of the transport element and/or of the transport unit along the direction that runs at least substantially parallel to the transport direction. The drive unit of the compression unit preferably comprises at least one electric motor. In particular, the electric motor of the drive unit of the compression unit is configured for a rotating drive of a drive element, in particular a drive roller or the like, of the drive unit of the compression unit, said drive element being configured, in a manner already known to someone skilled in the art, for a transmission of a drive force, in particular to a drive belt of the drive unit of the compression unit, for a movement of the compression element/s along the transport direction. The drive unit of the compression unit is preferably realized as a belt drive comprising a toothed belt which the compression element/s is/are arranged on, or as a chain drive comprising a drive chain which the compression element/s is/are arranged on. Alternatively or additionally, the drive unit of the compression unit may comprise further components, which are deemed expedient by someone skilled in the art and which are configured for a drive of the compression element/s along the transport direction, or the drive unit of the compression unit may have a different implementation deemed expedient by someone skilled in the art, such as for example an implementation as an electrodynamic linear or planar transport system, the functionality and construction of which is already known to someone skilled in the art under the product names XTS® or XPlanar® of the company Beckhoff Automation GmbH & Co. KG. If the drive unit of the compression unit is implemented as an electrodynamic linear or planar transport system, the drive unit of the compression unit preferably comprises a plurality of movement surface elements, which are in particular oriented horizontally or vertically, which are equipped with electromagnetic drive elements and which are connected to one another, in particular such that they together form a planar movement plane or a stator track. The electrodynamic linear or planar transport system preferably comprises a plurality of electrodynamically movable movers which are, in particular in a contact-free manner, movable relative to the movement surface elements, in particular as a result of an interaction of permanent magnets of the electrodynamically movable movers with the electromagnetic drive elements of the movement surface elements, wherein at least one compression element is arranged, in particular movably supported, on each electrodynamically movable mover in order to realize a movement of the compression element relative to the electrodynamically movable mover. It is also conceivable that the compression element/s can be driven along the transport direction by means of the drive unit of the transport unit, for example as a result of an operative connection of the drive unit of the transport unit with the compression element/s or by means of an operative connection of the transport element with the compression element/s, or the like.

It is further proposed that the compression element, in particular all compression elements, is/are supported, preferably in each case, so as to be movable relative to the transport unit along two directions that run transversely, in particular at least substantially perpendicularly, to each other. Preferentially, the compression element, in particular all compression elements in each case, has/have a linear movement axis which, in particular viewed in a plane extending at least substantially parallel to the horizontal plane, extends at least substantially perpendicularly to the transport direction. A movement of the compression element/s along the respective linear movement axis is preferably configured to realize a compression movement of the compression element/s for a compression of individual product groups, in particular product rows oriented transversely to the transport direction, of the products transported by the transport unit. Preferably, the two directions that run transversely, in particular at least substantially perpendicularly, to each other run at least substantially parallel to the horizontal plane. Preferably, one of the two directions that run transversely, in particular at least substantially perpendicularly, to each other runs at least substantially parallel to the transport direction and the other one of the two directions that run transversely, in particular at least substantially perpendicularly, to each other preferably runs at least substantially perpendicularly to the transport direction, in particular when viewed in a plane extending at least substantially parallel to the horizontal plane. Preferably, the compression element, in particular all compression elements, is/are movable relative to the transport unit at least substantially parallel to the transport direction by means of the drive unit of the compression unit, in particular by means of the drive element that is realized as a belt, preferably as a toothed belt. Preferably, the compression element, in particular all compression elements, is/are movable – independently of each other, preferably individually – relative to the transport unit along that one of the two directions that run transversely, in particular at least substantially perpendicularly, to each other which preferably runs at least substantially perpendicularly to the transport direction, in particular depending on a position of the compression element/s relative to the transport element along the transport direction. The compression element/s is/are preferably translationally movable relative to the transport unit along the one of the two directions that run transversely, in particular at least substantially perpendicularly, to each other which preferably runs at least substantially perpendicularly to the transport direction, in particular depending on a position of the compression element/s relative to the transport element along the transport direction. The compression unit preferably comprises at least one bearing element, which is in particular fixedly connected to the drive element that is realized as a belt, preferably as a toothed belt, on which, in particular in which, the compression element is supported so as to be, preferably translationally, movable, in particular along the one of the two directions that run transversely, in particular at least substantially perpendicularly, to each other which preferably runs at least substantially perpendicularly to the transport direction. Preferentially, the compression unit comprises a plurality of bearing elements, wherein preferably one bearing element is provided for each compression element, in particular in order to preferably realize individual, translationally movable support of each individual compression element. However, it is also conceivable that a plurality of compression elements are supported movably on a single bearing element. The implementation of the product handling device according to the invention advantageously allows realizing product-gentle compression of individual product groups over a movement path of the product groups along the transport direction, such that advantageously there is no abrupt compression but rather a slow and uniform compression of the product groups while they are still being moved along the transport direction. It is advantageously possible to realize – depending on a movement of the products along the transport direction – a continuous compression movement of the compression element along a direction that runs transversely to the transport direction. The implementation of the product handling device according to the invention advantageously allows realizing, in a structurally simple manner, a compression with a continuously increasing compression force. It is advantageously possible to realize a compression element that can be moved along with the products and/or the product groups along the transport direction, such that advantageously gentle product handling, high production output, high production reliability and/or high accuracy of a length measurement of product groups are/is achievable.

Furthermore, it is proposed that the compression unit comprises at least one, in particular circulating, preferably endless guiding and/or driving track, preferably the aforementioned guiding and/or driving track, by means of which a movement of the compression element, in particular of all compression elements, along the transport direction can be guided and/or induced, wherein the guiding and/or driving track extends for the most part, in particular completely, at least substantially parallel to the transport direction. The guiding and/or driving track may be defined or formed by the drive unit of the compression unit, in particular by the drive element that is realized as a belt, preferably as a toothed belt. Preferentially, the bearing element/s which is/are fixedly connected to the drive element that is realized as a belt, preferably as a toothed belt, is/are movable along the guiding and/or driving track, in particular circulating around a housing and/or guiding unit of the compression unit. Further implementations of the guiding and/or driving track, deemed expedient by someone skilled in the art, are likewise conceivable, such as for example an implementation of the guiding and/or driving track as a stator track of a drive unit of the compression unit, which is realized as an electrodynamic linear transport system. If the guiding and/or driving track is implemented as a stator track of a drive unit of the compression unit, which is realized as an electrodynamic linear transport system, the compression element is preferably arranged on an individually speed-controllable and/or position-controllable electrodynamic mover of the electrodynamic linear transport system. The implementation of the product handling device according to the invention advantageously allows achieving a reliable, in particular advantageously synchronous, moving-along of the compression element with the product groups along the transport direction. It is advantageously possible to realize a compression element that can be moved along with the products and/or the product groups along the transport direction, such that advantageously gentle product handling, high production output, high production reliability and/or high accuracy of a length measurement of product groups are/is achievable. The implementation of the product handling device according to the invention advantageously allows realizing product-gentle compression of individual product groups over a movement path of the product groups along the transport direction, such that advantageously there is no abrupt compression but rather a slow and uniform compression of the product groups while they are still being moved along the transport direction. This may in particular have a positive effect on product handling and on the accuracy of a length measurement of product groups. Advantageously it is possible to realize – depending on a movement of the products along the transport direction – a continuous compression movement of the compression element along a direction that runs transversely to the transport direction.

It is moreover proposed that the compression unit comprises at least one movement element, in particular a control cam, by means of which the compression element is movable, in particular translationally movable, relative to the transport unit, in particular as a result of a movement of the compression element along the transport direction, transversely, in particular at least substantially perpendicularly, to the transport direction. The movement element may be defined or realized by a guide groove or a guide web of the compression unit, in which a guide extension of the compression element/s engages or which engages in a guide groove of the compression element/s. It is conceivable that the movement element, which is in particular realized as a control cam, extends at least substantially parallel to the transport direction except for a section, in particular except for a control cam section, of the movement element by means of which a movement of the compression element/s can be induced relative to the transport unit, along the directions that run transversely, in particular at least substantially perpendicularly, to the transport direction, that the movement element, which is in particular realized as a control cam, is arranged only in a region of the guiding and/or driving track in which a movement of the compression element/s relative to the transport unit, along the directions that run transversely, in particular at least substantially perpendicularly, to the transport direction, is utilized for a compression of the product groups, or that the movement element has a different implementation and/or arrangement deemed expedient by someone skilled in the art, such as for example as a separate electric drive motor for the compression element, as a hydraulic or pneumatic cylinder acting on the compression element, or the like. If the drive unit of the compression unit is realized as an electrodynamic linear transport system, it is for example conceivable that the compression element is preferably supported so as to be movable on an individually speed-controllable and/or position-controllable electrodynamic mover of the electrodynamic linear transport system, wherein for a compression of individual product groups a movement of the compression element relative to the electrodynamic mover can be induced as a result of an interaction with the control cam, as a result of a self-drive of the compression element, as a result of a relative movement of two electrodynamic movers or in a different manner that is deemed expedient by someone skilled in the art. The implementation of the product handling device according to the invention allows inducing, in a structurally simple manner, a movement of the compression element for the purpose of compressing product groups. It is advantageously possible to realize a compression element that can be moved along with the products and/or the product groups along the transport direction, such that gentle product handling, high production output, high production reliability and/or high accuracy of a length measurement of product groups are/is advantageously achievable. The implementation of the product handling device according to the invention advantageously allows realizing, in a structurally simple manner, a compression with a continuously increasing compression force.

Beyond this it is proposed that the compression unit comprises at least one damping element, in particular a spring, which is configured for a force effect on the compression element, in particular in order to damp a force effect of the compression element onto the product group, in particular along the direction that runs transversely to the transport direction. The compression element is preferably supported so as to be movable, in a spring-loaded manner, by means of the damping element. Preferentially, the damping element, in particular the spring, is configured for a force effect on the compression element in a direction facing towards the transport unit, in particular for damping a force effect of the compression element onto the product group, in particular along the direction that runs transversely to the transport direction. However, it is also conceivable that the damping element, in particular the spring, is configured for a force effect on the compression element in a direction facing away from the transport unit, in particular for damping a force effect of the compression element onto the product group, in particular along the direction that runs transversely to the transport direction. The damping element is preferably embodied as a spring, in particular a spiral spring, a disk spring or the like. However, it is also conceivable that the damping element has a different implementation deemed expedient by someone skilled in the art, such as for example an implementation as an elastomer damper, as a gas compression spring or the like. The damping element is preferably supported with one side on the compression element, and with a further side the damping element is preferably supported on the bearing element. However, it is also conceivable that the damping element interacts with the compression element in a different manner, deemed expedient by someone skilled in the art, for the purpose of damping a force effect of the compression element onto the product group, in particular along the direction that runs transversely to the transport direction. The implementation of the product handling device according to the invention advantageously allows counteracting a damage to individual products in product groups during a compression. It is advantageously possible to counteract an unwanted machine stop, since an unwanted machine stop caused by fragments of products can be counteracted. An advantageous force effect on product groups is enabled, which may contribute to gentle compression and to reliable length measurement. It is advantageously possible to realize a compression element that can be moved along with the products and/or the product groups along the transport direction, such that gentle product handling, high production output, high production reliability and/or high accuracy of a length measurement of product groups are/is advantageously achievable.

Furthermore, it is proposed that the product handling device comprises at least one detection unit for a detection of a maximum extent of the product group, in particular of a maximum length of the product group that extends transversely to the transport direction, wherein the detection unit comprises at least one detection element, in particular a distance sensor, which interacts with the compression element for a detection of the maximum extent. It is conceivable that, in order to achieve the aforementioned objective, the product handling device is realized in an alternative implementation in a manner independent of the movement of the compression element together with the transport element. Preferably, in the alternative implementation, in particular in the implementation realized in a manner independent of the movement of the compression element together with the transport element, the product handling device comprises at least one transport unit for a transport of products along a transport direction of the transport unit, and comprises at least one compression unit for a compression of individual product groups, in particular product rows oriented transversely to the transport direction, of the products transported by the transport unit, the compression unit comprising at least one compression element, in particular a plunger, which is supported so as to be, in particular translationally, movable, wherein the product handling device comprises at least one detection unit for a detection of a maximum extent of the product group, in particular of a maximum length of the product group that extends transversely to the transport direction, wherein the detection unit comprises at least one detection element, in particular a distance sensor, which interacts with the compression element for a detection of the maximum extent. The detection unit is preferably realized as an electronic, preferably optoelectronic, detection unit, such as for example as a laser distance detection unit or the like. The detection element is preferably arranged on a side of the transport unit that is situated opposite the compression element/s. Preferably, the detection element is configured to emit a measurement signal, in particular a laser pulse, towards the compression element. Preferentially, the detection unit is configured to detect, as a result of a reflection of the emitted measurement signal on a surface of the compression element that faces towards the detection element and bears against the product group at an end of a compressed product group that faces away from the detection element, a distance between the detection element and the compression element that corresponds to a maximum length of the product group. However, it is also conceivable that the detection unit has a different implementation and/or functionality, deemed expedient by someone skilled in the art, for a detection of a maximum length of compressed product groups. The implementation of the product handling device according to the invention advantageously allows realizing a reliable detection of a maximum length of a compressed product group. Advantageously, gentle product handling, high production output, high production reliability and/or high accuracy of a length measurement of product groups are/is achievable.

Furthermore, the invention is based on a method for compressing individual product groups of transported products by means of a product handling device, in particular by means of a product handling device according to the invention. It is proposed that in at least one method step the compression element is, in particular at least temporarily, moved along the transport direction together with, preferably synchronously with, the transport element of the transport unit on which the products can be arranged. The compression element/s is/are preferably moved on or with the guiding and/or driving track in a circulating manner relative to the transport element and/or relative to the frame of the transport unit. The compression element/s is/are preferably moved along the transport direction on or with the guiding and/or driving track temporarily synchronously with the transport element of the transport unit on which the products can be arranged, in particular during a compression process. Preferentially, the compression element/s is/are temporarily moved on or with the guiding and/or driving track counter to the transport direction, in particular after completion of the compression process. The implementation according to the invention advantageously allows realizing a compression element that can be moved along with the products and/or the product groups along the transport direction, such that gentle product handling, high production output, high production reliability and/or high accuracy of a length measurement of product groups are/is advantageously achievable. The implementation according to the invention advantageously allows realizing product-gentle compression of individual product groups over a movement path of the product groups along the transport direction, such that advantageously there is no abrupt compression but rather a slow and uniform compression of the product groups while they are still being moved along the transport direction. This may in particular have a positive effect on product handling and on the accuracy of a length measurement of product groups. Advantageously, it is possible to realize – depending on a movement of the products along the transport direction – a continuous compression movement of the compression element along a direction that runs transversely to the transport direction. The implementation according to the invention advantageously allows realizing, in a structurally simple manner, a compression with a continuously increasing compression force. Advantageously, low-noise compression of the product groups can be realized, since compression does not take place abruptly at one point in time like in the prior art, but may advantageously take place continuously over a certain period of time.

It is further proposed that in at least one method step a movement of the compression element along the transport direction is superimposed by a movement of the compression element along a direction that runs transversely, in particular at least substantially perpendicularly, to the transport direction. Preferably, the compression element/s is/are moved by an influence of the movement element on the compression element/s along the direction that runs transversely, in particular at least substantially perpendicularly, to the transport direction towards the individual product groups of transported products, in particular in order to realize a compression of the product groups. The implementation according to the invention advantageously allows realizing product-gentle compression of individual product groups over a movement path of the product groups along the transport direction, such that advantageously there is no abrupt compression but rather a slow and uniform compression of the product groups while they are still being moved along the transport direction. This may in particular have a positive effect on product handling and on the accuracy of a length measurement of product groups. It is advantageously possible to realize – depending on a movement of the products along the transport direction – a continuous compression movement of the compression element along a direction that runs transversely to the transport direction.

Beyond this, it is proposed that in at least one method step a distance between the compression element and a detection element of a detection unit of the product handling device is detected, in particular in order to determine a maximum extent of the product group, in particular a maximum length of the product group that extends transversely to the transport direction. It is conceivable that the method for achieving the aforementioned objective is realized in an alternative implementation, in a manner independent of the movement of the compression element together with the transport element. Preferably, in the alternative implementation, in particular in the implementation realized in a manner independent of the movement of the compression element together with the transport element, the method is configured for a compression of individual product groups of transported products by a product handling device, in particular by a product handling device according to the invention, wherein in at least one method step a distance between the compression element and a detection element of a detection unit of the product handling device is detected, in particular in order to determine a maximum extent of the product group, in particular a maximum length of the product group that extends transversely to the transport direction. The implementation according to the invention advantageously allows realizing a reliable detection of a maximum length of a compressed product group. Advantageously, gentle product handling, high production output, high production reliability and/or high accuracy of a length measurement of product groups are/is achievable.

Moreover, a packaging machine for a packaging of products, in particular food products, with at least one product handling device according to the invention, is proposed. The packaging machine may comprise further devices and/or units which are deemed expedient by someone skilled in the art and are usable for a handling of products, in particular of food products. The packaging machine is preferably configured for a production, filling, packaging and/or secondary-packaging of food products. The packaging machine may comprise, in addition to the product handling device, for example a forming device for packagings, a cutting device, a filling device, a sterilization device, a closure device, a secondary-packaging device, a container feed device, a packaging device or the like. The implementation of the packaging machine according to the invention advantageously allows realizing a compression element that can be moved along with the products and/or the product groups along the transport direction, such that advantageously gentle product handling, high production output, high production reliability and/or high accuracy of a length measurement of product groups are/is achievable. The implementation of the packaging machine according to the invention advantageously allows realizing product-gentle compression of individual product groups over a movement path of the product groups along the transport direction, such that advantageously there is no abrupt compression but rather a slow and uniform compression of the product groups while they are still being moved along the transport direction. This may in particular have a positive effect on product handling and on the accuracy of a length measurement of product groups. Advantageously, it is possible to realize – depending on a movement of the products along the transport direction – a continuous compression movement of the compression element along a direction that runs transversely to the transport direction. The implementation of the packaging machine according to the invention advantageously allows realizing, in a structurally simple manner, a compression with a continuously increasing compression force. Advantageously, low-noise compression of the product groups can be realized, since compression does not take place abruptly at one point in time like in the prior art, but may advantageously take place continuously over a certain period of time.

The product handling device according to the invention, the method according to the invention and/or the packaging machine according to the invention shall here not be restricted to the application and implementation described above. In particular, in order to fulfil a functionality that is described here, the product handling device according to the invention, the method according to the invention and/or the packaging machine according to the invention may have a number of individual elements, components and units as well as method steps that differs from a number given here. Moreover, as for value ranges given in this disclosure, values lying within the stated limits shall also be considered to be disclosed and to be usable as desired.

### BRIEF DESCRIPTION OF THE DRAWINGS

Further advantages will become apparent from the following description of the drawings. An exemplary embodiment of the invention is illustrated in the drawings. The drawings, the description and the claims contain numerous features in combination. Someone skilled in the art will purposefully also consider the features individually and will find further expedient combinations.

In the drawings:

FIG. 1 packaging machine according to the invention with a product handling device according to the invention, in a schematic illustration,

FIG. 2 a detail view of the product handling device according to the invention, in a schematic illustration,

FIG. 3 a detail view of a compression unit of the product handling device according to the invention, in a schematic illustration, and

FIG. 4 shows a flowchart of a method according to the invention for compressing individual product groups of transported products by means of a product handling device, in a schematic illustration.

### DETAILED DESCRIPTION

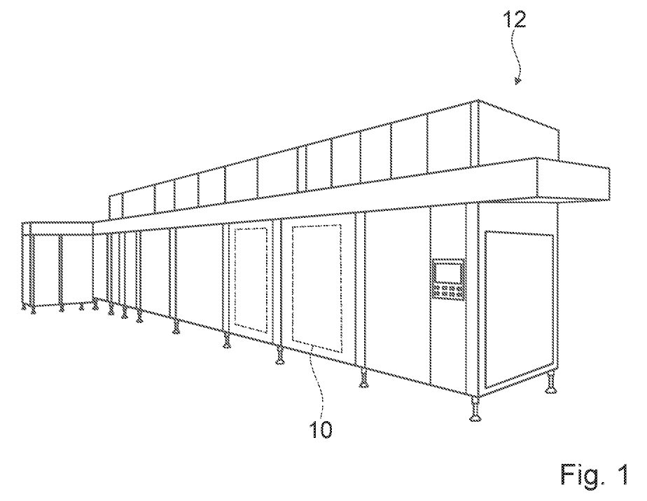

FIG. 1 shows an, in particular rather simplified, illustration of a packaging machine 12 at least for packaging products 16, in particular food products, such as for example biscuits, cookies, chocolate articles or the like. The packaging machine 12 comprises at least one product handling device 10 for a handling, like for example for a transport, for an orientation, for a sorting, for a compression or the like, of products 16. The packaging machine 12 is in particular embodied as a food production machine and/or food packaging machine. However, it is also conceivable that the packaging machine 12 has a different implementation deemed expedient by someone skilled in the art, such as for example as a pharmaceutical production machine and/or pharmaceutical packaging machine or the like. Alternatively or additionally, the packaging machine 12 may be configured for a production, processing and/or packaging of food products, such as for example biscuits, cookies, chocolate articles or the like. The packaging machine 12 preferably comprises, in addition to the product handling device 10, further devices and/or units deemed expedient by someone skilled in the art, which are used for a production, processing and/or packaging of food products, such as for example a sterilization device, a closure device, a secondary-packaging device, a control or regulation unit or the like.

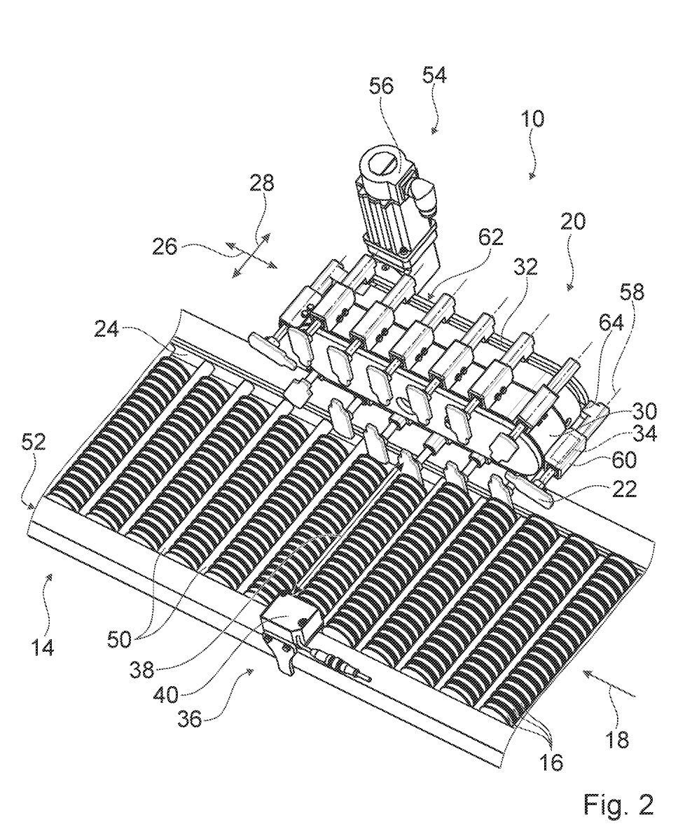

FIG. 2 shows a detail view of the product handling device 10 in a schematic illustration. The product handling device 10 for the packaging machine 12 comprises at least one transport unit 14 for a transport of products 16 along a transport direction 18 of the transport unit 14, and comprises at least one compression unit 20 for a compression of individual product groups, in particular of product rows oriented transversely to the transport direction 18, of the products 16 which are transported by the transport unit 14, the compression unit 20 comprising at least one compression element 22, in particular a plunger, which is supported so as to be, in particular translationally, movable. The transport unit 14 is preferably realized as a rod conveyor unit, in particular as a transverse rod conveyor unit. However, it is also conceivable that the transport unit 14 has a different implementation deemed expedient by someone skilled in the art, such as for example an implementation as a chain conveyor, as a conveyor belt, as a belt conveyor, as an electrodynamic linear or planar transport system, the functionality and construction of which is already known to someone skilled in the art under the product names XTS® or XPlanar® of the company Beckhoff Automation GmbH & Co. KG, or the like.

Preferably the transport unit 14 comprises at least one transport element 24, which is preferably realized as a rod belt, preferably as a transverse rod belt. Preferentially the transport element 24 is realized as a circulating rod belt. The transport element 24 is preferably supported movably, in particular in a circulating manner, on a guide unit 52, in particular on a frame, of the transport unit 14. The transport unit 14 preferably comprises at least one drive unit (not shown in detail here) for a movement, in particular for a circulating drive, of the transport element 24 relative to the guide unit 52. The transport unit 14 is preferably configured to transport the products 16 along the transport direction 18 in such a way that the products 16 are oriented transversely, in particular at least substantially perpendicularly, to the transport direction 18 in rows, in particular as a result of an arrangement of individual product groups of the products 16 in each case between two transverse rods 50 of the transport unit 14, in particular of the transport element 24. The transport direction 18 along which the products 16 can be conveyed, in particular in the form of product groups, preferably product rows, which are oriented transversely to the transport direction 18, preferably extends at least substantially parallel to a horizontal plane. Preferably the transport direction 18 extends at least substantially parallel to a longitudinal axis of the transport unit 14. In a state in which they are arranged between the two transverse rods 50, the products 16 may have small distances along a direction 28 extending transversely to the transport direction 18, and/or individual products 16 of a product group may be arranged between the two transverse rods 50 in such a way that not all products 16 of the product group bear against one another over their entire surface, in particular before the products 16 have passed the compression unit 20 during a transport along the transport direction 18.

The compression unit 20 is preferably configured to compress the individual product groups arranged between two transverse rods 50, in particular product rows oriented transversely to the transport direction 18 and arranged between two transverse rods 50, of the products 16 transported by the transport unit 14. Preferably, individual products 16 of the individual product groups are movable towards one another by the compression unit 20 along the direction 28 that runs transversely to the transport direction 18, in particular at least substantially perpendicularly to the transport direction 18 and at least substantially parallel to the horizontal plane, preferably until the products 16 of the individual product groups bear against one another. For an effect, in particular a force effect, along the direction 28 that runs transversely to the transport direction 18, on the products 16 of the individual product groups, the compression unit 20 preferably comprises at least the compression element 22, which is supported so as to be, in particular translationally, movable. For an effect on the products 16 of the individual product groups at least along the direction 28 that runs transversely to the transport direction 18, in particular at least substantially perpendicularly to the transport direction 18 and at least substantially parallel to the horizontal plane, the compression element 22 is preferably supported so as to be translationally movable relative to the transport unit 14. However, it is also conceivable that, in particular at least for an effect on the products 16 of the individual product groups, the compression element 22 is alternatively or additionally supported movably relative to the transport unit 14 in a different manner and along a different direction, deemed expedient by someone skilled in the art. The compression element 22 is preferably realized as a plunger. However, it is also conceivable that the compression element 22 has a different implementation deemed expedient by someone skilled in the art, such as for example an implementation as a slider, as a rod, as a rake or the like. Preferably, the compression unit 20 comprises a plurality of compression elements 22, wherein the individual compression elements 22 are in each case configured for an effect, in particular a force effect, along the direction 28 that runs transversely to the transport direction 18, on products 16 of an individual product group arranged between two transverse rods 50. The compression elements 22 are preferably implemented identically. However, it is also conceivable that the compression elements 22 are implemented differently.

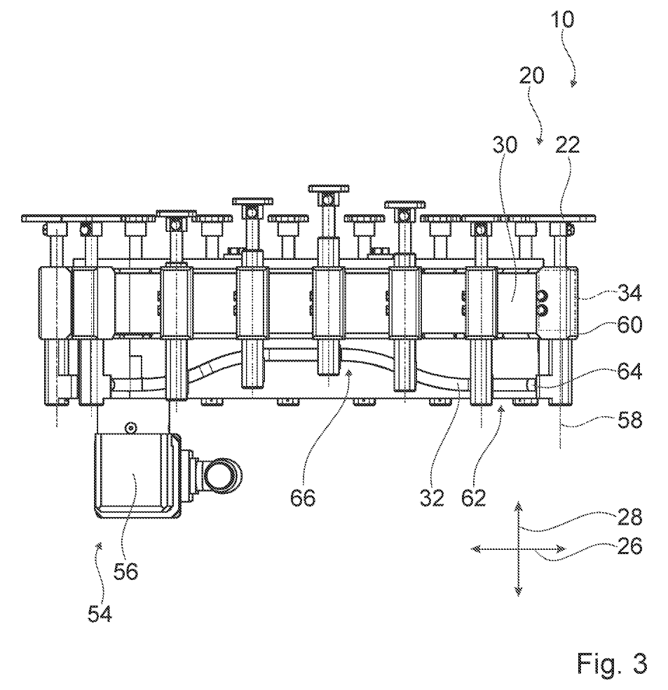

The compression element 22 is preferentially, in particular at least temporarily, movable along the transport direction 18 together with, preferably synchronously with, the transport element 24 of the transport unit 14 on which the products 16 can be arranged. The compression element 22 is, in particular at least temporarily, movable along the transport direction 18 together with, preferably synchronously with, the transport element 24 of the transport unit 14 on which the products 16 can be arranged. The compression unit 20 preferably comprises at least one drive unit 54 for a movement of the compression element/s 22 along the transport direction 18 relative to the guide unit 52 of the transport unit 14 (cf. FIGS. 2 and 3). The drive unit 54 of the compression unit 20 is preferably configured to move the compression element/s 22 in a circulating manner on or with a guiding and/or driving track 30, which is arranged laterally offset relative to the transport element 24 and/or relative to the guide unit 52 of the transport unit 14, in particular in order to move the compression element/s 22 along the transport direction 18 at least temporarily together with, preferably synchronously with, the transport element 24 of the transport unit 14 on which the products 16 can be arranged. The drive unit 54 of the compression unit 20 preferably comprises at least one electric motor 56. In particular, the electric motor 56 of the drive unit 54 of the compression unit 20 is configured for a rotating drive of a drive element (not shown in detail here), in particular a drive roller or the like, of the drive unit 54 of the compression unit 20, said drive element being configured, in a manner already known to someone skilled in the art, for a transmission of a drive force, in particular to a drive belt of the drive unit 54 of the compression unit 20, said drive belt preferably forming the guiding and/or driving track 30, for a movement of the compression element/s 22 along the transport direction 18. The drive unit 54 of the compression unit 20 is preferably embodied as a belt drive comprising the drive belt that is realized as a toothed belt and on which the compression element/s 22 is/are arranged. Alternatively or additionally, the drive unit 54 of the compression unit 20 may comprise further components which are deemed expedient by someone skilled in the art and which are configured for a drive of the compression element/s 22 along the transport direction 18, or the drive unit 54 of the compression unit 20 may have a different implementation deemed expedient by someone skilled in the art, such as for example an implementation as an electrodynamic linear or planar transport system, the functionality and construction of which are already known to someone skilled in the art under the product names XTS® or XPlanar® of the company Beckhoff Automation GmbH & Co. KG.

The compression element 22 is preferably supported movably relative to the transport unit 14 and/or relative to a housing and/or guiding unit 62 of the compression unit 20 along the two directions 26, 28 that run transversely, in particular at least substantially perpendicularly, to each other (cf. FIGS. 2 and 3). Preferentially, the compression element 22, in particular all compression elements 22 in each case, has/have a linear movement axis 58 which, in particular viewed in a plane extending at least substantially parallel to the horizontal plane, extends at least substantially perpendicularly to the transport direction 18. A movement of the compression element/s 22 along the respective linear movement axis 58 is preferably configured to bring about a compression movement of the compression element/s 22 for a compression of individual product groups, in particular product rows oriented transversely to the transport direction 18, of the products 16 transported by the transport unit 14. Preferably, the two directions 26, 28 that run transversely, in particular at least substantially perpendicularly, to each other run at least substantially parallel to the horizontal plane. Preferably, one of the two directions 26, 28 that run transversely, in particular at least substantially perpendicularly, to each other runs at least substantially parallel to the transport direction 18 and the other one of the two directions 26, 28 that run transversely, in particular at least substantially perpendicularly, to each other preferably runs at least substantially perpendicularly to the transport direction 18, in particular when viewed in a plane extending at least substantially parallel to the horizontal plane. Preferably, the compression element 22, in particular all compression elements 22 together, is/are movable relative to the transport unit 14 at least substantially parallel to the transport direction 18 by means of the drive unit 54 of the compression unit 20, in particular by means of the drive element that is realized as a belt, preferably as a toothed belt. Preferentially, the compression element 22, in particular all compression elements 22, is/are movable independently of each other, preferably individually, relative to the transport unit 14 along the one of the two directions 26, 28 that run transversely, in particular at least substantially perpendicularly, to each other, which preferably runs at least substantially perpendicularly to the transport direction 18, in particular depending on a position of the compression element/s 22 relative to the transport element 24 along the transport direction 18. The compression element/s 22 is/are preferably translationally movable relative to the transport unit 14 along the one of the two directions 26, 28 that run transversely, in particular at least substantially perpendicularly, to each other, which preferably runs at least substantially perpendicularly to the transport direction 18, in particular depending on a position of the compression element/s 22 relative to the transport element 24 along the transport direction 18. The compression unit 20 preferably comprises at least one bearing element 60, which is in particular fixedly connected to the drive element that is realized as a belt, preferably as a toothed belt (cf. FIGS. 2 and 3), on which, in particular in which, the compression element 22 is supported so as to be movable, preferably translationally movable, in particular along the one of the two directions 26, 28 that run transversely, in particular at least substantially perpendicularly, to each other, which preferably runs at least substantially perpendicularly to the transport direction 18. Preferentially, the compression unit 20 comprises a plurality of bearing elements 60, wherein preferably one bearing element 60 is provided for each compression element 22, in particular in order to preferably realize individual, translationally movable support of each individual compression element 22. However, it is also conceivable that a plurality of compression elements 22 are supported movably on a single bearing element 60.

The compression unit 20 comprises at least the, in particular circulating, preferably endless, guiding and/or driving track 30, by means of which a movement of the compression element 22 along the transport direction 18 can be guided and/or induced, wherein the guiding and/or driving track 30 extends for the most part at least substantially parallel to the transport direction 18 (cf. FIG. 2). The guiding and/or driving track 30 is preferably defined or realized by the drive element that is realized as a belt, preferably as a toothed belt. Preferentially, the bearing element/s 60 is/are fixedly connected with the drive element that is realized as a belt, preferably as a toothed belt. The bearing element/s 60 is/are preferably movable along the guiding and/or driving track 30, in particular circulating around the housing and/or guiding unit 62 of the compression unit 20. Further implementations of the guiding and/or driving track 30, deemed expedient by someone skilled in the art, are likewise conceivable, like for example an implementation of the guiding and/or driving track 30 as a stator track of a drive unit of the compression unit 20, which is realized as an electrodynamic linear transport system.

The compression unit 20 preferably comprises at least one movement element 32, in particular a control cam, by means of which the compression element 22 is movable, in particular translationally movable, relative to the transport unit 14 and/or relative to the housing and/or guiding unit 62 of the compression unit 20, in particular as a result of a movement of the compression element 22 along the transport direction 18, transversely, in particular at least substantially perpendicularly, to the transport direction 18 (cf. FIG. 3). The movement element 32 is preferably defined or realized by a guide groove of the compression unit 20, in which a guide extension 64 of the compression element 22/s engages. Preferentially the movement element 32, which is in particular realized as a control cam, extends - except for a section 66, in particular except for a control cam section, of the movement element 32, by means of which a movement of the compression element 22/s can be induced, along the directions 28 that run transversely, in particular at least substantially perpendicularly, to the transport direction 18 relative to the transport unit 14 and/or relative to the housing and/or guiding unit 62 of the compression unit 20 – at least substantially parallel to the transport direction 18. However, it is also conceivable that the movement element 32 has a different implementation and/or arrangement deemed expedient by someone skilled in the art, such as for example an implementation as a separate electric drive motor for the compression element 22, as a hydraulic or pneumatic cylinder acting on the compression element 22, or the like.

Preferentially the compression unit 20 comprises at least one damping element 34 (indicated in FIG. 2 only by dashed lines), in particular a spring, which is configured for a force effect onto the compression element 22, in particular for damping a force effect of the compression element 22 on the product group, in particular along the direction 28 that runs transversely to the transport direction 18. The compression element 22 is preferably supported so as to be movable, in a spring-loaded manner, by means of the damping element 34. Preferentially the damping element 34, in particular the spring, is configured for a force effect onto the compression element 22 in a direction facing towards the transport unit 14, in particular for damping a force effect of the compression element 22 on the product group, in particular along the direction 28 that runs transversely to the transport direction 18. However, it is also conceivable that the damping element 34, in particular the spring, is configured for a force effect onto the compression element 22 in a direction facing away from the transport unit 14, in particular for damping a force effect of the compression element 22 on the product group, in particular along the direction 28 that runs transversely to the transport direction 18. The damping element 34 is preferably realized as a spring, in particular a spiral spring, a disk spring or the like. However, it is also conceivable that the damping element 34 has a different implementation deemed expedient by someone skilled in the art, such as for example an implementation as an elastomer damper, as a gas compression spring or the like. The damping element 34 is preferably supported with one side on the compression element 22, and with a further side the damping element 34 is preferably supported on the bearing element 60. However, it is also conceivable that, for damping a force effect of the compression element 22 on the product group, in particular along the direction 28 that runs transversely to the transport direction 18, the damping element 34 interacts with the compression element 22 in a different manner that is deemed expedient by someone skilled in the art.

The product handling device 10 preferably comprises at least one detection unit 36 for a detection of a maximum extent 38 of the product group, in particular of a maximum length of the product group extending transversely to the transport direction 18, wherein the detection unit 36 comprises at least one detection element 40, in particular a distance sensor, which interacts with the compression element 22 for a detection of the maximum extent 38 (cf. FIG. 2). The detection unit 36 is preferentially realized as an electronic, preferably optoelectronic, detection unit 36, such as for example as a laser distance detection unit or the like. The detection element 40 is preferably arranged on a side of the transport unit 14 that is situated opposite the compression element/s 22. Preferably, the detection element 40 is configured to emit a measurement signal, in particular a laser pulse, towards the compression element 22. Preferentially, the detection unit 36 is configured to detect, as a result of a reflection of the emitted measurement signal on a surface of the compression element 22 that faces towards the detection element 40 and bears against the product group at an end of a compressed product group that faces away from the detection element 40, a distance between the detection element 40 and the compression element 22 that corresponds to a maximum length of the product group. However, it is also conceivable that the detection unit 36 has a different implementation and/or functionality, deemed expedient by someone skilled in the art, for a detection of a maximum length of compressed product groups.

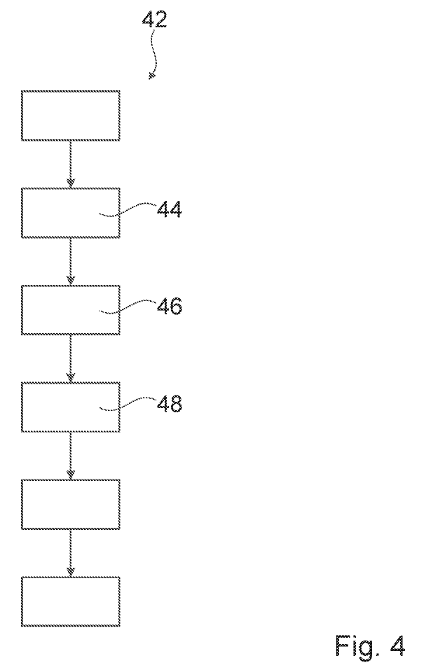

FIG. 4 shows a flowchart of a method 42 for compressing individual product groups of transported products 16 by means of the product handling device 10, in a schematic illustration. In the method 42 for compressing individual product groups of transported products 16 by means of the product handling device 10, in at least one method step 44 the compression element 22 is, in particular at least temporarily, moved along the transport direction 18 together with, preferably synchronously with, the transport element 24 of the transport unit 14 on which the products 16 can be arranged. In at least one, in particular further, method step 46 of the method 42, a movement of the compression element 22 along the transport direction 18 is preferably superimposed by a movement of the compression element 22 along the direction 28 that runs transversely, in particular at least substantially perpendicularly, to the transport direction 18. Preferably, in at least one, in particular further, method step 48 of the method 42, a distance between the compression element 22 and the detection element 40 of the detection unit 36 of the product handling device 10 is detected, in particular in order to determine the maximum extent 38, in particular the maximum length of the product group extending transversely to the transport direction 18. The method 42 for compressing individual product groups of transported products 16 may comprise further method steps which are deemed expedient by someone skilled in the art. Moreover, possible method steps which can be derived from the description of FIGS. 1 to 3 shall also be considered to be disclosed for the method 42.

1. A product handling device for a packaging machine, comprising:
at least one transport unit (14) for a transport of products (16) along a transport direction (18) of the transport unit (14); and
at least one compression unit (20) for a compression of individual product groups of the products (16) transported by the transport unit (14),
wherein the at least one compression unit (20) comprises at least one compression element (22) which is supported so as to be movable, wherein the at least one compression element (22) is movable along the transport direction (18) together with at least one transport element (24) of the at least one transport unit (14) on which the products (16) can be arranged.

2. The product handling device according to claim 1, wherein the at least one compression element (22) is supported so as to be movable relative to the at least one transport unit (14) along two directions (26, 28) that run transversely to each other.

3. The product handling device according to claim 1, wherein the at least one compression unit (20) comprises at least one guiding and/or driving track (30), by which a movement of the at least one compression element (22) along the transport direction (18) can be guided and/or induced, wherein the at least one guiding and/or driving track (30) extends at least substantially parallel to the transport direction (18).

4. The product handling device according to claim 1, wherein the at least one compression unit (20) comprises at least one movement element (32), by which the at least one compression element (22) is movable relative to the at least one transport unit (14) transversely to the transport direction (18).

5. The product handling device according to claim 1, wherein the at least one compression unit (20) comprises at least one damping element (34), which is configured for a force effect on the at least one compression element (22).

6. The product handling device according to claim 1, further comprising at least one detection unit (36) for a detection of a maximum extent (38) of an individual product group, wherein the at least one detection unit (36) comprises at least one detection element (40), which interacts with the at least one compression element (22) for a detection of the maximum extent (38).

7. A method for compressing individual product groups of transported products (16) by a product handling device according to claim 1, wherein in at least one method step (44) the at least one compression element (22) is moved along the transport direction (18) together with the at least one transport element (24) of the at least one transport unit (14), on which the products (16) can be arranged.

8. The method according to claim 7, wherein in at least one method step (46) a movement of the at least one compression element (22) along the transport direction (18) is superimposed by a movement of the at least one compression element (22) along a direction (28) that runs transversely to the transport direction (18).

9. The method according to claim 7, wherein in at least one method step (48) a distance between the at least one compression element (22) and a detection element (40) of a detection unit (36) of the product handling device is detected.

10. A packaging machine for a packaging of products (16), comprising at least one product handling device according to claim 1.

11. A product handling device for a packaging machine, comprising:
at least one transport unit (14) for a transport of products (16) along a transport direction (18) of the at least one transport unit (14);
at least one compression unit (20) for a compression of individual product groups of the products (16) transported by the at least one transport unit (14); and
at least one detection unit (36) for a detection of a maximum extent (38) of an individual product group;
wherein the at least one compression unit (20) comprises at least one compression element (22) which is supported so as to be movable, wherein the at least one detection unit (36) comprises at least one detection element (40), which interacts with the at least one compression element (22) for a detection of the maximum extent (38) of the individual product group.

12. A method for compressing individual product groups of transported products (16) by a product handling device according to claim 1, wherein in at least one method step (48) a distance between the at least one compression element (22) and a detection element (40) of a detection unit (36) of the product handling device is detected.

13. The method according to claim 8, wherein in at least one method step (48) a distance between the at least one compression element (22) and a detection element (40) of a detection unit (36) of the product handling device is detected.
